(19) United States
(12) Patent Application Publication
(10) Pub. No.: US 2026/0245276 A1
(43) Pub. Date: Aug. 20, 2026

(54) IMAGE PROCESSING METHOD AND APPARATUS, DEVICE AND STORAGE MEDIUM

(71) Applicant: Beijing Zitiao Network Technology Co., Ltd, Beijing (CN)

(72) Inventor: Lang CHEN, Beijing (CN)

(21) Appl. No.: 19/164,506

(22) PCT Filed: Mar. 18, 2024
(86) PCT No.: PCT/CN2024/082106

§ 371 Date: Sep. 11, 2025

(30) Foreign Application Priority Data
Mar. 17, 2023 (CN) 202310263887.2

(51) Int. Cl. G06T 11/60; G06V 10/40; G06V 10/762; G06V 10/764; G06V 40/16

(52) U.S. Cl. CPC G06T 11/60; G06V 10/40; G06V 10/762; G06V 10/764; G06V 40/171; G06V 40/172

(57) ABSTRACT

The present disclosure provides an image processing method and apparatus, an electronic device, and a storage medium. The method includes: obtaining an original image; obtaining a target identifier, wherein the target identifier is configured to indicate a stylization type of the original image; and inputting the original image and the target identifier to an image stylization model to obtain a target stylized image.

This application claims priority to Chinese Patent Application No. 202310263887.2 filed on Mar. 17, 2023, the entire disclosure of which is incorporated herein by reference as part of the present disclosure.

### TECHNICAL FIELD

The present disclosure relates to an image processing method and apparatus, device, and a storage medium.

### BACKGROUND

At present, a user can stylize an image through the stylization function of the client. That is, the user can stylize an image captured by the camera, for example, into the anime style or the movie and television play style, through the stylization software of the client.

However, the existing client may only have a single stylization feature, which leads to a small difference in style experience between users and hence a similar stylization result. The small degree of distinction will affect the use experience of the users.

### SUMMARY

In view of the above, the present disclosure provides an image processing method and apparatus, device, and a storage medium, to increase the diversity of stylized images generated by the model, and improve the user experience.

To realize the above objections, the present disclosure provides following technical solutions.

On the first aspect, the present disclosure provides an image processing method, comprising: obtaining an original image; obtaining a target identifier, wherein the target identifier is configured to indicate a stylization type of the original image; and inputting the original image and the target identifier to an image stylization model to obtain a target stylized image.

On the second aspect, the present disclosure provides an image processing apparatus, comprising: a first obtaining unit configured to obtain an original image; a second obtaining unit configured to obtain a target identifier, wherein the target identifier is configured to indicate a stylization type of the original image; and a third obtaining unit configured to input the original image and the target identifier to an image stylization model to obtain a target stylized image.

On the third aspect, the present disclosure provides an electronic device, comprising a processor and a memory, wherein the memory is configured to store instructions or a computer program; and the processor is configured to execute the instructions or the computer program in the memory to cause the electronic device to perform the image processing method according to the above first aspect.

On the fourth aspect, the present disclosure provides a computer-readable storage medium, storing instructions which, when run on a device, cause the device to perform the image processing method according to the above first aspect.

On the fifth aspect, the present disclosure provides a computer program product, comprising a computer program or instructions which, when executed by a processor, implements/implement the image processing method according to the above first aspect.

### BRIEF DESCRIPTION OF DRAWINGS

In order to clearly illustrate the technical solution of the embodiments of the invention, the drawings of the embodiments will be briefly described in the following; it is obvious that the described drawings are only related to some embodiments of the invention. Other accompanying drawings can also be derived from these drawings by those ordinarily skilled in the art without creative efforts.

FIG. 1 is a flowchart of an image processing method provided by an embodiment of the present disclosure;

FIG. 2 is a flowchart of a method for training an image generation model provided by an embodiment of the present disclosure;

FIG. 3 is a schematic diagram of a stylized image provided by an embodiment of the present disclosure;

FIG. 4 is a schematic diagram of an image processing apparatus provided by an embodiment of the present disclosure; and

FIG. 5 is a structural schematic diagram of an electronic device provided by an embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the embodiments of the present disclosure, those skilled in the art can obtain other embodiment(s), without any inventive work, which should be within the scope of the invention.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user. For example, in response to receiving an active request from a user, a prompt message is sent to the user to explicitly prompt the user that the operation the user requests to perform will require to obtain and use the personal information of the user. Thus, the user can freely select, according to the prompt message, whether or not to provide the personal information to software or hardware such as an electronic device, an application, a server or a storage medium that performs the operations of the technical solutions of the present disclosure.

As an alternative but non-limiting implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” and “disagree” with providing personal information to an electronic device.

It will be appreciated that an image generated by a method provided by the embodiments of the present disclosure should be processed in accordance with the provisions of the relevant laws and regulations. For example, as required, an identifier that does not affect the use of the user is added by taking a technical measure; or, as required, a significant identifier is provided in a reasonable position or region to present deep synthesis for the public.

It will be appreciated that the processes of notifying of and authorizing by a user and processing images described above are merely exemplary and do not constitute a limitation on the implementations of the present disclosure, and other manners meeting relevant laws and regulations may also be applied to the implementations of the present disclosure.

At present, the user can stylize an image, for example, into the anime style or the movie and television play style, by means of the stylization function of the client. However, the existing client may only have a single stylization feature, which leads to a small difference in style experience between users and hence a similar stylization result, thereby affecting the use experience of the users.

On this basis, an embodiment of the present disclosure provides an image processing method to increase the diversity of the generated stylized images and improving the user experience. In a particular implementation, in order to increase the diversity of the generated stylized images, a model may be pre-trained with sample data having many features to obtain a trained image stylization model. When the user uses the image stylization model to obtain a stylized image, a target identifier can be obtained. The target identifier may be configured to indicate a stylization type of an original image. Thus, after the original image and the target identifier are input to the image stylization model, a target stylized image corresponding to the target identifier can be obtained. With the method provided in the embodiments of the present disclosure, the model can be trained with samples of different styles to increase the diversity of stylized images generated by the model, and the distinction between different styles may also be increased to improve the user experience.

For ease of understanding of the technical method provided by the embodiments of the present disclosure, the technical solutions provided by the embodiments of the present disclosure will be described below in conjunction with the drawings.

With reference to FIG. 1, FIG. 1 is a flowchart of an image generation method provided by an embodiment of the present disclosure.

The image generation method can be applied to a client, and includes the following steps.
S101: an original image is obtained.

In order to obtain a stylized image of the original image, the client can collect the original image by means of a camera. Optionally, the original image may be a real facial image shot in real time, or may be a picture taken from a facial image.
S102: a target identifier is obtained. The target identifier is configured to indicate a stylization type of the original image.

In this embodiment, different stylized images generated by the client have different identifiers. Different target identifiers can be input at the client to obtain images of corresponding stylization types.

Optionally, the target identifier may be obtained in the following manner. The client may preset some preset conditions and may determine the corresponding target identifiers when different preset conditions are met. That is, after obtaining the original image, the client may analyze a target object in the original image to determine a preset condition that the target object meets, thereby determining the target identifier corresponding to the preset condition. The preset condition may include: facial forms with different characteristics, different key point data, etc.

Moreover, the client may preset various identifiers in a display interface of a stylized image software, each identifier corresponding to a type of stylized images. In response to an operation of selecting an identifier by the user, the target identifier is obtained. That is, the user may select an identifier in the display interface and enter a corresponding stylized image interface to obtain a stylized image corresponding to the selected identifier. Alternatively, after the user obtains a target stylized image in the stylized image interface, the user may switch the stylized image interface to switch different identifiers, thereby obtaining different target stylized images.
S103: the original image and the target identifier are input to an image stylization model to obtain a target stylized image.

After the client obtains the original image and the target identifier, the original image and the target identifier can be input to the image stylization model to obtain the corresponding target stylized image. The image stylization model is pre-trained. For ease of understanding of the principle of generating a stylized image, the training process of the image stylization model will be described below.

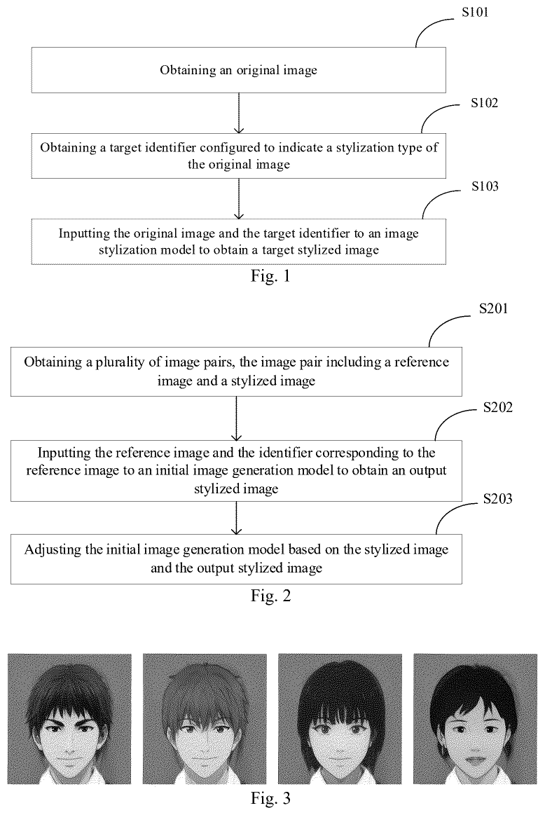

With reference to FIG. 2, FIG. 2 is a flowchart of a method for training an image generation model provided by an embodiment of the present disclosure.

The method may be performed by a server, e.g., by a processing device of the server. The method may include the following steps.
S201: a plurality of image pairs are obtained, wherein an image pair includes a reference image and a stylized image.

In order to enable an image stylization model to generate more categories of stylized images, more categories of sample data may be obtained and employed to train an initial image generation model. The sample data is the plurality of image pairs, each image pair including a reference image and a stylized image. Each image pair has a corresponding identifier for distinguishing between style types of different image pairs.

Optionally, the plurality of image pairs may be obtained in the following manner. Firstly, a stylized image set is obtained, wherein the stylized image set includes a plurality of stylized images. For example, the stylized images may be anime stylized images, e.g., person images in animes such as Detective Conan, Slam Dunk, and Naruto, or may be stylized images in movie and television plays, such as Condor Heroes, and Journey to the West. In this embodiment, a stylized image type meeting an effect definition may be preset to obtain the stylized image set. For example, only stylized images in line with the anime style may be set as samples. The stylized image set is then clustered to obtain a plurality of subcategory image sets. By classifying a first stylized image set, the distinguishability and differences between different categories of stylized images can be increased, thereby improving the quality of stylized images in each subcategory.

After obtaining the plurality of subcategory image sets by clustering, a plurality of identifiers corresponding to the plurality of subcategory image sets may be determined, wherein the plurality of subcategory image sets are in one-to-one correspondence with the plurality of identifiers. That is, each subcategory image set uniquely corresponds to one identifier, and the identifier can be used to distinguish between different types of stylized images. It needs to be noted that the particular manner of setting the identifiers is not limited in this embodiment. For example, letters “a, b, c” and the like may be used to distinguish between different categories of image pairs. Alternatively, for any category of image pairs, pixel values of stylized images included in this category may also be subjected to normalization processing, a value obtained after the normalization processing may be used as the identifier corresponding to this category of image pairs, and a value range of the identifier is [0,1].

A subcategory stylized image corresponding to a reference image is obtained using the plurality of subcategory image sets, and the reference image and the corresponding subcategory stylized image are used as an image pair. This may be specifically achieved in the following manner. For any one of the plurality of subcategory image sets, an initial generator is trained with the subcategory image set to obtain a trained first generator. The subcategory image set is in one-to-one correspondence with the first generator. That is, each subcategory image set is employed to trained one generator. In this way, a plurality of generators respectively corresponding to the plurality of subcategory image sets are obtained. For any first generator, a plurality of reference images are input to the first generator to correspondingly obtain a plurality of stylized images. That is, the plurality of reference images are in one-to-one correspondence with the plurality of stylized images. For any of the plurality of reference images, the reference image and the stylized image corresponding to the reference image for an image pair. For the first generator trained with each subcategory image set, the above same steps are performed, thus obtaining a plurality of image pairs of different categories as sample data. The identifier corresponding to each image pair is the identifier corresponding to the subcategory image set. The category of the image pairs is identical to that of the subcategory image set obtained by clustering the stylized image set, and the count of the image pairs is also identical to the count of the first generators.

In a possible implementation, the stylized image set may be an acquired initial stylized image set, e.g., person images directly taken from an anime. In order to guarantee the diversity of samples, person images with different features may be obtained. For example, facial images from various angles may be selected.

Optionally, in order to further improve the sufficiency and diversity of the samples, the stylized image set may be obtained by expanding based on initial stylized images. For example, after the initial stylized image set is obtained, a second generator may be trained with the initial stylized image set such that a discrimination model of the second generator cannot discriminate whether the stylized image generated by the generation model is a real sample. Thus, a trained third generator is obtained. A random variable set is then input to the third generator to obtain a first stylized image set. The random variable set includes a plurality of random variables. By inputting any random variable set to the third generator, a corresponding stylized image can be obtained. In this way, a plurality of stylized images are obtained as the first stylized image set. The initial stylized image set and the first stylized image set can be then combined into the stylized image set.

When the original image is a facial image, an acquired original stylized image might include different face angles. Therefore, the stylized images of a plurality of face angles can be obtained to improve the diversity and sufficiency of the samples. An original stylized image set is classified based on a preset angle range set to obtain a plurality of angle stylized image sets. When the number of original stylized images in a certain angle stylized image set is less than a threshold, a supplementary angle stylized image set matching a face angle of the angle stylized image set is generated, thereby forming the stylized image set.

In a possible implementation, after the random variable set is input to the third generator to obtain a second stylized image set, the server can also perform face attribute recognition on the second stylized image set to obtain the face angle of each stylized image. After determining the face angle of each stylized image, the server may classify the second stylized image set according to the preset angle range set, thereby determining an angle stylized image set corresponding to each angle range. This embodiment does not limit a particular manner of dividing the preset angle range set of facial images. For example, the preset angle range set may be set to include −90° to 30°, −30° to 0°, 0° to 30°, and 30° to 90°, etc., wherein 0° may represent that the facial image shows front face; when the face in the facial image is leftwards, its angle is negative; and when the face in the facial image is rightwards, its angle is positive.

When the number of stylized images in a certain angle stylized image set is less than a threshold, it indicates that the sample data in this angle range is not enough, and a target random variable set corresponding to the angle stylized images within this angle range may be obtained to realize sample supplementation. That is, the target random variable set is input to the third generator again to obtain a supplementary angle stylized image set matching the angle range. The second stylized image set and the regenerated supplementary angle stylized image set are combined into the second stylized image set. The sufficiency of the sample features is improved.

In a possible implementation, clustering on the stylized image set may be realized in the following manner. For any stylized image in the stylized image set, feature extraction is performed on the stylized image to obtain a feature vector. Optionally, feature extraction may be performed on an image using a convolutional neural network. That is, by performing feature extraction on each image in the stylized image set using the convolutional neural network, a plurality of corresponding feature vectors can be obtained. The feature vector can be used to represent the feature information of the image. After the feature vector corresponding to each image in the stylized image set is obtained, the plurality of feature vectors are clustered to obtain a plurality of feature vector sets that correspond to a plurality of subcategory image sets. According to the feature vectors included in each feature vector set, an image set belonging to this category can be determined.

Optionally, the clustering of the plurality of feature vectors may be realized using a K-means clustering algorithm. The basic principle of the K-means clustering algorithm is as follows: firstly, k feature vectors are randomly selected from the plurality of feature vectors as an initial clustering center, and then a distance, e.g., a Euclidean distance, between each feature vector and each seed clustering center is then calculated. Each feature vector is assigned to the nearest clustering center. After this clustering is completed, each clustering center and the feature vectors assigned to it represent one cluster, and the clustering center of each cluster is recalculated according to the feature vectors included in this cluster. For example, the sum of the distances from the clustering center to all feature vectors in the cluster is minimum. According to the recalculated clustering center, the feature vectors are reassigned. This clustering process is repeated until a certain termination condition is met. For example, the termination condition may be no feature vector being reassigned to a different cluster or no clustering center changing.
S202: reference images and identifiers corresponding to the reference images are input to an initial image generation model to obtain output stylized images.

After the identifier corresponding to each image pair is determined, the initial image generation model can be trained based on the image pairs and the corresponding identifiers. In a particular implementation, a plurality of reference images and the identifiers corresponding to the plurality of reference images may be input to an initial image generation model to obtain a plurality of output stylized images, wherein a plurality of facial images are in one-to-one correspondence with the plurality of output stylized images.
S203: the initial image generation model is adjusted based on the stylized images and the output stylized images.

Since the sample data includes a plurality of image pairs, i.e., each reference image corresponds to one stylized image, a loss function can be determined based on a plurality of stylized images and a plurality of output stylized images corresponding to a plurality of reference images. The loss function can be configured to represent a difference between a stylized image in an image pair and an output stylized image, i.e., the accuracy of the initial image generation model. When the loss function is greater, it indicates that the difference between the stylized image the output stylized image is greater, that is, the initial image generation model is more inaccurate. For example, a first feature vector of any stylized image in an image pair and a second feature vector of the output stylized image corresponding to the stylized image may be obtained, and the feature vectors can be used to represent the features of the images. A similarity between the first feature vector and the second feature vector is then calculated as the loss function.

When the loss function is greater than or equal to a preset value, parameters of the initial image generation model are adjusted, and inputting a plurality of images in the sample data and identifiers corresponding to the plurality of images to the initial image generation model and the subsequent training process are performed again until the loss function is less than the preset vale, thereby obtaining the image stylization model.

When the loss function is greater than or equal to the preset value, it indicates that the accuracy of the initial image generation model does not meet the requirement, and the parameters of the initial image generation model can be adjusted, and inputting a plurality of reference images and identifiers corresponding to the plurality of reference images to the initial image generation model and the subsequent training process are performed again until the determined loss function is less than the preset vale, thereby obtaining the trained image stylization model.

With the method for training an image generation model provided in the above embodiment, the image generation model can be trained with more categories of samples so as to increase the diversity of the generated stylized images. Moreover, when training the model, the identifiers of different types of stylized images can be determined by clustering. Thus, the distinction between the different types of stylized images can be increased, and the user experience can be improved. With reference to FIG. 3, FIG. 3 is a schematic diagram of a stylized image provided by an embodiment of the present disclosure. When a plurality of image pairs include four types of identifiers, four stylized images obtained by inputting a facial image are as shown in FIG. 3.

When a server obtains an image stylization model by training, the server may provide it to a client, and the client has the function to generate a stylized image by means of the image stylization model. The function of the client to generate a stylized image may be a stylized image generation software. That is, a user can obtain a stylized image according to an image through the function of the client to generate a stylized image. The client may be a device such as a mobile phone and a tablet computer.

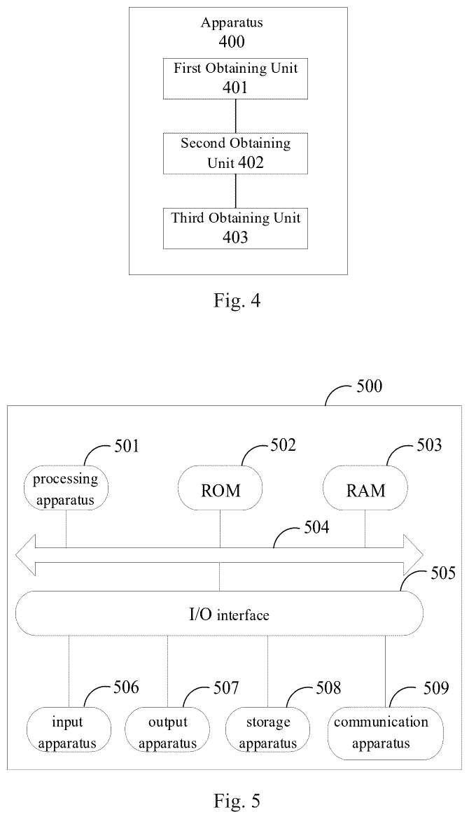

Based on the above-mentioned method embodiments, an embodiment of the present disclosure provides an image processing apparatus. With reference to FIG. 4, FIG. 4 is a schematic diagram of an image processing apparatus provided by an embodiment of the present disclosure.

The image processing apparatus 400 includes: a first obtaining unit 401 configured to obtain an original image; a second obtaining unit 402 configured to obtain a target identifier, wherein the target identifier is configured to indicate a stylization type of the original image; and a third obtaining unit 403 configured to input the original image and the target identifier to an image stylization model to obtain a target stylized image.

In a possible implementation, the second obtaining unit 402 is specifically configured to: analyze a target object in the original image; and when the target object meets a preset condition, obtain a target identifier corresponding to the preset condition; or obtain the target identifier in response to an operation of a user selecting an identifier.

In a possible implementation, the image processing apparatus 400 further includes a fourth obtaining unit. The fourth obtaining unit is configured to: obtain a plurality of image pairs, the image pair including a reference image and a stylized image, and the image pair having a corresponding identifier for distinguishing between style types of different image pairs; input the reference images and the identifier corresponding to the reference image to an initial image generation model to obtain an output stylized image; and adjust the initial image generation model based on the stylized image and the output stylized image.

In a possible implementation, the fourth obtaining unit is specifically configured to: obtain a stylized image set; cluster the stylized image set to obtain a plurality of subcategory image sets; determine a plurality of identifiers corresponding to the plurality of subcategory image sets, wherein the plurality of subcategory image sets are in one-to-one correspondence with the plurality of identifiers; with the plurality of subcategory image sets, obtain subcategory stylized images corresponding to the reference images; and use the reference images and the corresponding subcategory stylized images as the image pairs, wherein the identifiers corresponding to the image pairs are identical to the identifiers corresponding to the subcategory image sets.

In a possible implementation, the fourth obtaining unit is specifically configured to: obtain an original stylized image set; perform attribute recognition on the original stylized image set to determine an angle of an original stylized image in the original stylized image set; classify the original stylized image set based on a preset angle range set to obtain a plurality of angle stylized image sets; and when a number of original stylized images in the angle stylized image set is less than a threshold, generate a supplementary angle stylized image set matching an angle of the angle stylized image set, thereby forming the stylized image set.

In a possible implementation, the fourth obtaining unit is specifically configured to: perform feature extraction on the stylized image to obtain a feature vector; cluster a plurality of feature vectors to obtain a plurality of feature vector sets; and determine the plurality of subcategory image sets based on the plurality of feature vectors.

For the beneficial effects the image processing apparatus provided by this embodiment of the present disclosure has, a reference may be made to the above method embodiments, which will not be described redundantly here.

It needs to be noted that for specific implementations of the units in this embodiment, a reference may be made to the related descriptions in the above method embodiments. The division of units in this embodiment of the present disclosure is schematic, which is merely logical function division, and there may be another division method in actual implementation. Functional units in the embodiment of the present disclosure may be integrated into one processing unit, or each of the units may exist alone physically, or two or more units are integrated into one unit. For example, in the above embodiment, the processing unit and the sending unit may be a same unit or may be different units. The above integrated unit may be implemented either in a form of hardware or in a form of a software functional unit.

Referring to FIG. 5, there is shown the schematic structural diagram of the electronic device 500 adapted to implement embodiments of the present disclosure. The terminal device in the embodiment of the present disclosure may include but not be limited to mobile terminals such as a mobile phone, a notebook computer, a digital broadcasting receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in FIG. 5 is merely an example, and should not pose any limitation to the functions and the range of use of the embodiments of the present disclosure.

As shown in FIG. 5, the electronic device 500 may include a processing apparatus (e.g., a central processing unit, a graphics processing unit) 501, which can perform various suitable actions and processing according to a program stored in a read-only memory (ROM) 502 or a program loaded from a storage apparatus 508 into a random access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a loudspeaker, and a vibrator; a storage apparatus 508 including, for example, a magnetic tape and a hard disk; and a communication apparatus 509. The communication apparatus 509 may allow the electronic device 500 to be in wireless or wired communication with other devices to exchange data. While FIG. 5 illustrates the electronic device 500 having various apparatuses, it is to be understood that all the illustrated apparatuses are not necessarily implemented or included. More or less apparatuses may be implemented or included alternatively.

Particularly, according to the embodiments of the present disclosure, the process described above with reference to the flowchart may be implemented as a computer software program. For example, an embodiment of the present disclosure includes a computer program product, which includes a computer program carried by a non-transitory computer-readable medium. The computer program includes a program code for performing the method shown in the flowchart. In such an embodiment, the computer program may be downloaded online through the communication apparatus 509 and installed, or installed from the storage apparatus 508, or installed from the ROM 502. When the computer program is executed by the processing apparatus 501, the functions defined in the method of the embodiments of the present disclosure are executed.

The electronic device provided in this embodiment of the present disclosure and the method provided in the foregoing embodiments belong to the same inventive concept. For technical details not described in detail in this embodiment, a reference may be made to the foregoing embodiments, and this embodiment and the foregoing embodiments have the same beneficial effects.

An embodiment of the present disclosure provides a computer storage medium, storing a computer program which, when executed by a processor, causes the method provided by the above embodiments to be implemented.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include but be not limited to an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

In some implementations, a client and a server may communicate by means of any network protocol currently known or to be developed in future such as Hyper Text Transfer Protocol (HTTP), and may achieve communication and interconnection with digital data (e.g., a communication network) in any form or of any medium. Examples of the communication network include a local area network (LAN), a wide area network (WAN), an Internet work (e.g., the Internet), a peer-to-peer network (e.g., ad hoc peer-to-peer network), and any network currently known or to be developed in future.

The above-mentioned computer-readable medium may be included in the electronic device described above, or may exist alone without being assembled with the electronic device.

The above-mentioned computer-readable medium carries one or more programs which, when executed by the electronic device, cause the electronic device to perform the method described above.

A computer program code for performing the operations in the present disclosure may be written in one or more programming languages or a combination thereof. The programming languages include but are not limited to object oriented programming languages, such as Java, Smalltalk, and C++, and conventional procedural programming languages, such as C or similar programming languages. The program code may be executed fully on a user computer, executed partially on a user computer, executed as an independent software package, executed partially on a user computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that, in some alternative implementations, the functions marked in the blocks may alternatively be carried out in an order different from that marked in the drawings. For example, two successively shown blocks actually may be executed in parallel substantially, or may be executed in reverse order sometimes, depending on the functions involved. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

Related units described in the embodiments of the present disclosure may be implemented by software, or may be implemented by hardware. The name of a unit/module does not constitute a limitation on the unit itself.

The functions described above in the present disclosure may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium include: an electrical connection with one or more wires, a portable computer disk, a hard disk, a random access memory (RAM), a read-only memory (ROM), an erasable programmable ROM (an EPROM or a flash memory), an optical fiber, a portable compact disc read-only memory (CD-ROM), an optical storage device, a magnetic storage device, or any suitable combination thereof.

According to one or more embodiments of the present disclosure, there is provided an image processing method, including: obtaining an original image; obtaining a target identifier, wherein the target identifier is configured to indicate a stylization type of the original image; and inputting the original image and the target identifier to an image stylization model to obtain a target stylized image.

According to one or more embodiments of the present disclosure, the obtaining a target identifier includes: analyzing a target object in the original image, and when the target object meets a preset condition, obtaining a target identifier corresponding to the preset condition; or in response to an operation of a user selecting an identifier, obtaining the target identifier.

According to one or more embodiments of the present disclosure, the image stylization model is obtained based on the following steps: obtaining a plurality of image pairs, wherein the image pairs include reference images and stylized images; and the image pairs have corresponding identifiers for distinguishing between style types of different image pairs; inputting the reference images and the identifiers corresponding to the reference images to an initial image generation model to obtain output stylized images; and adjusting the initial image generation model based on the stylized images and the output stylized images.

According to one or more embodiments of the present disclosure, the obtaining a plurality of image pairs includes: obtaining a stylized image set; clustering the stylized image set to obtain a plurality of subcategory image sets; determining a plurality of identifiers corresponding to the plurality of subcategory image sets, wherein the plurality of subcategory image sets are in one-to-one correspondence with the plurality of identifiers; with the plurality of subcategory image sets, obtaining subcategory stylized images corresponding to the reference images; and using the reference images and the corresponding subcategory stylized images as the image pairs, wherein the identifiers corresponding to the image pairs are identical to the identifiers corresponding to the subcategory image sets.

According to one or more embodiments of the present disclosure, the obtaining a stylized image set includes: obtaining an original stylized image set; performing attribute recognition on the original stylized image set to determine an angle of an original stylized image in the original stylized image set; classifying the original stylized image set based on a preset angle range set to obtain a plurality of angle stylized image sets; and when a number of original stylized images in the angle stylized image set is less than a threshold, generating a supplementary angle stylized image set matching an angle of the angle stylized image set, thereby forming the stylized image set.

According to one or more embodiments of the present disclosure, the clustering the stylized image set to obtain a plurality of subcategory image sets includes: performing feature extraction on the stylized image to obtain a feature vector; clustering a plurality of feature vectors to obtain a plurality of feature vector sets; and determining the plurality of subcategory image sets based on the plurality of feature vectors.

According to one or more embodiments of the present disclosure, there is provided an image processing apparatus, including: a first obtaining unit configured to obtain an original image; a second obtaining unit configured to obtain a target identifier, wherein the target identifier is configured to indicate a stylization type of the original image; and a third obtaining unit configured to input the original image and the target identifier to an image stylization model to obtain a target stylized image.

In one or more embodiments of the present disclosure, the second obtaining unit is specifically configured to: analyze a target object in the original image, and when the target object meets a preset condition, obtain a target identifier corresponding to the preset condition; or in response to an operation of a user selecting an identifier, obtain the target identifier.

In one or more embodiments of the present disclosure, the image processing apparatus further includes a fourth obtaining unit. The fourth obtaining unit is configured to: obtain a plurality of image pairs, wherein the image pairs include reference images and stylized images; and the image pairs have corresponding identifiers for distinguishing between style types of different image pairs; input the reference images and the identifiers corresponding to the reference images to an initial image generation model to obtain output stylized images; and adjust the initial image generation model based on the stylized images and the output stylized images.

In one or more embodiments of the present disclosure, the fourth obtaining unit is specifically configured to: obtain a stylized image set; cluster the stylized image set to obtain a plurality of subcategory image sets; determine a plurality of identifiers corresponding to the plurality of subcategory image sets, wherein the plurality of subcategory image sets are in one-to-one correspondence with the plurality of identifiers; with the plurality of subcategory image sets, obtain subcategory stylized images corresponding to the reference images; and use the reference images and the corresponding subcategory stylized images as the image pairs, wherein the identifiers corresponding to the image pairs are identical to the identifiers corresponding to the subcategory image sets.

In one or more embodiments of the present disclosure, the fourth obtaining unit is specifically configured to: obtain an original stylized image set; perform attribute recognition on the original stylized image set to determine an angle of an original stylized image in the original stylized image set; classify the original stylized image set based on a preset angle range set to obtain a plurality of angle stylized image sets; and when a number of original stylized images in the angle stylized image set is less than a threshold, generate a supplementary angle stylized image set matching an angle of the angle stylized image set, thereby forming the stylized image set.

In one or more embodiments of the present disclosure, the fourth obtaining unit is specifically configured to: perform feature extraction on the stylized image to obtain a feature vector; cluster a plurality of feature vectors to obtain a plurality of feature vector sets; and determine the plurality of subcategory image sets based on the plurality of feature vectors.

According to one or more embodiments of the present disclosure, there is provided an electronic device, including a processor and a memory; wherein the memory is configured to store instructions or a computer program; and the processor is configured to execute the instructions or the computer program in the memory to cause the electronic device to perform the image processing method.

According to one or more embodiments of the present disclosure, there is provided a computer-readable storage medium, storing instructions which, when run on a device, cause the device to perform the image processing method.

It should be noted that, the embodiments in the present disclosure are described in a progressive manner. Each embodiment focuses on the difference from another embodiment, and the same and similar parts between the embodiments may refer to each other. Since the system or apparatus disclosed in an embodiment corresponds to the method disclosed in another embodiment, the description is relatively simple, and a reference can be made to the method description.

It will be appreciated that, in the present disclosure, the phrase “at least one” refers to one or more, and the phrase “a plurality of” refers to two or more. The term “and/or” is used for describing an association relationship of associated objects, and represents that three relationships may exist. For example, A and/or B may represent that: A exists alone, B exists alone, and A and B exist at the same time, where A and B may be singular or plural. The character “/” usually represents an “or” relationship between associated objects. The phrase “at least one of the following items” or a similar expression thereof refers to any combination of these items, including a single item or any combination of plural items. For example, “at least one of a, b, or c” may represent: a, b, c, “a and b”, “a and c”, “b and c”, or “a and b and c”, where a, b, and c may each be a single or plural item.

It should be noted that, in the present disclosure, relational terms such as first and second are merely used to distinguish one entity or operation from another entity or operation without necessarily requiring or implying any actual such relationship or order between such entities or operations. In addition, terms “include”, “comprise”, or any other variations thereof are intended to cover a non-exclusive inclusion, so that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in the process, method, article, or device including the elements.

The steps of the method or algorithm described in combination with the embodiments of the present disclosure may be directly implemented by hardware, software modules executed by a processor, or a combination of both. The software modules may be placed in a random access memory (RAM), an internal memory, a read-only memory (ROM), an electrically programmable ROM, an electrically erasable programmable ROM, a register, a hard disk, a removable disk, a compact disc read-only memory (CD-ROM), or a storage medium in any other form well known in the art.

The above descriptions of the disclosed embodiments can enable a person skilled in the art to implement or practice the present disclosure. A plurality of amendments to are apparent to those skilled in the art, and general principles defined in the present disclosure can be achieved in the other examples without departing from the spirit or scope of the present disclosure. Thus, the present disclosure will not be limited to these embodiments shown in the present disclosure, but shall accord with the widest scope consistent with the principles and novel characteristics of the present disclosure.

1. An image processing method, comprising:
obtaining an original image;
obtaining a target identifier, wherein the target identifier is configured to indicate a stylization type of the original image; and
inputting the original image and the target identifier to an image stylization model to obtain a target stylized image.

2. The image processing method according to claim 1, wherein the obtaining a target identifier comprises:
analyzing a target object in the original image, and when the target object meets a preset condition, obtaining a target identifier corresponding to the preset condition; or
in response to an operation of selecting an identifier by a user, obtaining the target identifier.

3. The image processing method according to claim 1, wherein the image stylization model is obtained based on following steps:
obtaining a plurality of image pairs, wherein the plurality of image pairs comprise reference images and stylized images, and the plurality of image pairs have corresponding identifiers for distinguishing between style types of different image pairs;
inputting the reference images and the identifiers corresponding to the reference images to an initial image generation model to obtain output stylized images; and
adjusting the initial image generation model based on the stylized images and the output stylized images.

4. The image processing method according to claim 3, wherein the obtaining a plurality of image pairs comprises:
obtaining a stylized image set;
clustering the stylized image set to obtain a plurality of subcategory image sets;
determining a plurality of identifiers corresponding to the plurality of subcategory image sets, wherein the plurality of subcategory image sets are in one-to-one correspondence with the plurality of identifiers;
obtaining subcategory stylized images corresponding to the reference images using the plurality of subcategory image sets; and
using the reference images and the corresponding subcategory stylized images as the image pairs, wherein the identifiers corresponding to the image pairs are identical to the identifiers corresponding to the subcategory image sets.

5. The image processing method according to claim 4, wherein the obtaining a stylized image set comprises:
obtaining an original stylized image set;
performing attribute recognition on the original stylized image set to determine an angle of an original stylized image in the original stylized image set;
classifying the original stylized image set based on a preset angle range set to obtain a plurality of angle stylized image sets; and
when a count of original stylized images in an angle stylized image set is less than a threshold, generating a supplementary angle stylized image set matching an angle of the angle stylized image set, thereby constituting the stylized image set.

6. The image processing method according to claim 4, wherein the clustering the stylized image set to obtain a plurality of subcategory image sets comprises:
performing feature extraction on each stylized image of the stylized image set to obtain a feature vector;
clustering a plurality of feature vectors to obtain a plurality of feature vector sets; and
determining the plurality of subcategory image sets based on the plurality of feature vectors.

7. (canceled)

8. An electronic device, comprising a processor and a memory, wherein the memory is configured to store instructions or a computer program; and
the processor is configured to execute the instructions or the computer program in the memory to cause the electronic device to perform the an image processing method comprising:
obtaining an original image;
obtaining a target identifier, wherein the target identifier is configured to indicate a stylization type of the original image; and
inputting the original image and the target identifier to an image stylization model to obtain a target stylized image.

9. A computer-readable storage medium, storing instructions which, when run on a device, cause the device to perform an image processing method comprising:
obtaining an original image;
obtaining a target identifier, wherein the target identifier is configured to indicate a stylization type of the original image; and
inputting the original image and the target identifier to an image stylization model to obtain a target stylized image.

10. (canceled)

11. The electronic device according to claim 8, wherein the obtaining a target identifier comprises:
analyzing a target object in the original image, and when the target object meets a preset condition, obtaining a target identifier corresponding to the preset condition; or
in response to an operation of selecting an identifier by a user, obtaining the target identifier.

12. The electronic device according to claim 8, wherein the image stylization model is obtained based on following steps:
obtaining a plurality of image pairs, wherein the plurality of image pairs comprise reference images and stylized images, and the plurality of image pairs have corresponding identifiers for distinguishing between style types of different image pairs;
inputting the reference images and the identifiers corresponding to the reference images to an initial image generation model to obtain output stylized images; and
adjusting the initial image generation model based on the stylized images and the output stylized images.

13. The electronic device according to claim 12, wherein the obtaining a plurality of image pairs comprises:
obtaining a stylized image set;
clustering the stylized image set to obtain a plurality of subcategory image sets;
determining a plurality of identifiers corresponding to the plurality of subcategory image sets, wherein the plurality of subcategory image sets are in one-to-one correspondence with the plurality of identifiers;
obtaining subcategory stylized images corresponding to the reference images using the plurality of subcategory image sets; and
using the reference images and the corresponding subcategory stylized images as the image pairs, wherein the identifiers corresponding to the image pairs are identical to the identifiers corresponding to the subcategory image sets.

14. The electronic device according to claim 13, wherein the obtaining a stylized image set comprises:
obtaining an original stylized image set;
performing attribute recognition on the original stylized image set to determine an angle of an original stylized image in the original stylized image set;
classifying the original stylized image set based on a preset angle range set to obtain a plurality of angle stylized image sets; and
when a count of original stylized images in an angle stylized image set is less than a threshold, generating a supplementary angle stylized image set matching an angle of the angle stylized image set, thereby constituting the stylized image set.

15. The electronic device according to claim 13, wherein the clustering the stylized image set to obtain a plurality of subcategory image sets comprises:
performing feature extraction on each stylized image of the stylized image set to obtain a feature vector;
clustering a plurality of feature vectors to obtain a plurality of feature vector sets; and
determining the plurality of subcategory image sets based on the plurality of feature vectors.

16. The computer-readable storage medium according to claim 9, wherein the obtaining a target identifier comprises:
analyzing a target object in the original image, and when the target object meets a preset condition, obtaining a target identifier corresponding to the preset condition; or
in response to an operation of selecting an identifier by a user, obtaining the target identifier.

17. The computer-readable storage medium according to claim 9, wherein the image stylization model is obtained based on following steps:
obtaining a plurality of image pairs, wherein the plurality of image pairs comprise reference images and stylized images, and the plurality of image pairs have corresponding identifiers for distinguishing between style types of different image pairs;
inputting the reference images and the identifiers corresponding to the reference images to an initial image generation model to obtain output stylized images; and
adjusting the initial image generation model based on the stylized images and the output stylized images.

18. The computer-readable storage medium according to claim 17, wherein the obtaining a plurality of image pairs comprises:
obtaining a stylized image set;
clustering the stylized image set to obtain a plurality of subcategory image sets;
determining a plurality of identifiers corresponding to the plurality of subcategory image sets, wherein the plurality of subcategory image sets are in one-to-one correspondence with the plurality of identifiers;
obtaining subcategory stylized images corresponding to the reference images using the plurality of subcategory image sets; and
using the reference images and the corresponding subcategory stylized images as the image pairs, wherein the identifiers corresponding to the image pairs are identical to the identifiers corresponding to the subcategory image sets.

19. The computer-readable storage medium according to claim 18, wherein the obtaining a stylized image set comprises:
obtaining an original stylized image set;
performing attribute recognition on the original stylized image set to determine an angle of an original stylized image in the original stylized image set;
classifying the original stylized image set based on a preset angle range set to obtain a plurality of angle stylized image sets; and
when a count of original stylized images in an angle stylized image set is less than a threshold, generating a supplementary angle stylized image set matching an angle of the angle stylized image set, thereby constituting the stylized image set.

20. The computer-readable storage medium according to claim 18, wherein the clustering the stylized image set to obtain a plurality of subcategory image sets comprises:
performing feature extraction on each stylized image of the stylized image set to obtain a feature vector;
clustering a plurality of feature vectors to obtain a plurality of feature vector sets; and
determining the plurality of subcategory image sets based on the plurality of feature vectors.
